(19) United States
(12) Patent Application Publication
(10) Pub. No.: US 2009/0302571 A1
(43) Pub. Date: Dec. 10, 2009

(54) WHEELCHAIR WITH TRANSFER BOARD

(76) Inventors: R. Kent Osborn, Mableton, GA (US); Randy L. Bernard, Atlanta, GA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/482,222

(22) Filed: Jun. 10, 2009

Related U.S. Application Data
(60) Provisional application No. 61/060,403, filed on Jun. 10, 2008.

(51) Int. Cl. A61G 5/10

(52) U.S. Cl. 280/304.1

(57) ABSTRACT

A combination wheelchair and transfer board having a flip-back armrest. The flip-back armrest lowers upon and secures the transfer board in a vertical position at the side of the wheelchair. The armrest includes a channel for receiving a top edge of the transfer board. When the armrest is rotated back, the channel releases the top of the transfer board and the armrest is moved backwards sufficiently so that the transfer board is free to move upward. A rear landing pad is provided that supports and secures the transfer board in the vertical position at the side of the wheelchair. The rear landing pad pivots with the armrest. A plastic, self-locking plug permits the transfer board to be attached to a standard armrest receiver on a wheelchair. The self-locking plug snaps into place, and includes either a swedged portion or tabs to lock it into place.

### CROSS-REFERENCES TO RELATED APPLICATIONS

This application claims the benefit of provisional application No. 61/060,403 (Attorney Docket No. 027578-000100US), filed on Jun. 10, 2008, the full disclosure of which is incorporated herein by reference.

### BACKGROUND

A transfer board is a thin tapered board used as a bridge for an individual to slide from one armless chair, bed, or seating surface to another. Transfer boards are often used by individuals that have a limited ability to bear weight directly on their lower extremities. This inability can be due to amputation, lack of sufficient muscular control (such as with a spinal cord injury, stroke, M.S., etc.), or lack of balance and coordination (such as with stroke or traumatic brain injury).

Most wheelchairs are equipped with removable armrests to facilitate the use of transfer boards, if needed. The armrest is removed and the transfer board is positioned to extend from the seating surface of the wheelchair to the surface upon which the wheelchair occupant plans to move. The degree of independence exhibited by an individual using a transfer board is governed by his or her ability to: reach and control the transfer board with one or both upper extremities; position the wheelchair and remove the armrest; shift weight and place the transfer board underneath the buttocks; bear weight with upper extremities and slide across the transfer board; remove the transfer board at the conclusion of transfer, and overcome the fear of falling to allow for all of the aforementioned tasks.

One problem encountered in these transfers is an inability of the wheelchair user to remove and reattach the armrest to the wheelchair. The user must use visual or tactile skills to locate the spring pin which locks the armrest to the wheelchair. Then, the user must release and lift the armrest from its attachments on the wheelchair (often with the use of only one arm), and place the armrest aside where it is accessible for reattachment. The user must then reattach the armrest after returning to the wheelchair. In the cases of memory and motor deficits or tremors, the tasks of releasing the armrest and guiding it in and out of its two cylindrical attachments (one of which is outside the view of the individual) is often difficult.

For stability, 5 to 8 inches of the transfer board is typically placed underneath the transferee prior to transfer. It is often difficult for the transferee to shift weight and place the transfer board this far underneath the buttocks. Even with proper placement, the board can still slide laterally with the transferee, precipitating a fall.

Because transfers are rarely between surfaces of equal height, transfer boards tend to shift unnecessarily when weight is shifted during a transfer from a higher to a lower surface. This can cause the above-described lateral sliding of the transfer board. For individuals with limited mobility, the possibility of falling is a very justifiable concern. Knowing that the transfer board is securely attached at one location would be of great benefit.

Another problem with transfer boards is transportation. Few wheelchair dependent individuals can reach, place, and remove the transfer board from a backpack/holder behind the wheelchair. Thus, unless the wheelchair occupant anticipates having assistance, he or she must carry the three foot transfer board on his or her lap. This positioning of the transfer board inhibits arm propulsion of the wheelchair.

U.S. Pat. Nos. 5,947,501 and 6,036,216 have a common inventor to this disclosure, and are directed to a wheelchair with a detachable combined armrest and transfer board. The transfer board is attached to the wheelchair by a unique coupling. The transfer board is linked to the seating surface of the wheelchair and is reconfigurable from a first position in which the transfer board extends along one side of the seating surface to a second position in which the transfer board is capable of extending from the seating surface of the wheelchair to a second seating surface remote of the wheelchair. The coupling permits unrestricted movement of the transfer board relative to the wheelchair while maintaining a linkage between the wheelchair and the transfer board, thus aiding in stability of the transfer board.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Embodiments herein are directed to improvements to the combined wheelchair and transfer board disclosed in U.S. Pat. Nos. 5,947,501 and 6,036,216.

In accordance with an embodiment, a combination wheelchair and transfer board is provided having a flip-back armrest. The flip-back armrest lowers upon and secures the transfer board in a vertical position at the side of the wheelchair. The armrest includes a channel for receiving a top edge of the transfer board. When the armrest is rotated back, the channel releases the top of the transfer board and the armrest is moved backwards sufficiently so that the transfer board is free to move upward.

In accordance with an embodiment, a rear landing pad is provided that supports and secures the transfer board in the vertical position at the side of the wheelchair. The rear landing pad pivots with the armrest. In an embodiment, the rear landing pad includes a sidewall for securing an outer surface of the transfer board, a support surface, and a sleeve for mounting on a post for the flip-back armrest.

In accordance with another embodiment, a plastic, self-locking plug is provided that permits the transfer board to be attached to a standard armrest receiver on a wheelchair. The self-locking plug snaps into place, and includes either a swedged portion or tabs to lock it into place.

For a fuller understanding of the nature and advantages of the present invention, reference should be made to the ensuing detailed description and accompanying drawings.

### BRIEF DESCRIPTION OF THE DRAWINGS

FIG. 1 is a side perspective view of a prior art wheelchair design with a removable armrest;

FIG. 2 is a side perspective view of a prior art wheelchair having a transfer board in accordance with U.S. Pat. Nos. 5,947,501 and 6,036,216, the transfer board being mounted in the stowed or vertical position;

FIG. 3 is a rear side perspective view, with parts removed for detail, of a prior art removable armrest for placement on the prior art transfer board of FIG. 2;

FIG. 4 is a side perspective view of a prior art coupling with parts removed for detail for attaching the prior art transfer board of FIG. 2 to the wheelchair;

FIG. 5 is a side perspective view of a prior art front mount for attaching the coupling of FIG. 4 to the wheelchair of FIG. 2;

FIG. 6 is a side perspective view of a prior art rear mount for receiving the back end of the transfer board of FIG. 2;

FIG. 7 is a side perspective view of a prior art wheelchair having a transfer board in accordance with U.S. Pat. Nos. 5,947,501 and 6,036,216, with the transfer board in the transfer position and extended to a seating surface, such as a bed;

FIG. 8 is partial cutaway, side view of a combination wheelchair and transfer board in accordance with an embodiment;

FIG. 9 is a bottom right, rear perspective view of a rear landing pad for the transfer board of FIG. 8;

FIG. 10 is a front left perspective view of the combination wheelchair and transfer board of FIG. 8, with an armrest rotated back and out of the way, and with the transfer board shown partially rotated towards a use position;

FIG. 11 is section view of armrest receiver of the wheelchair of FIG. 8.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

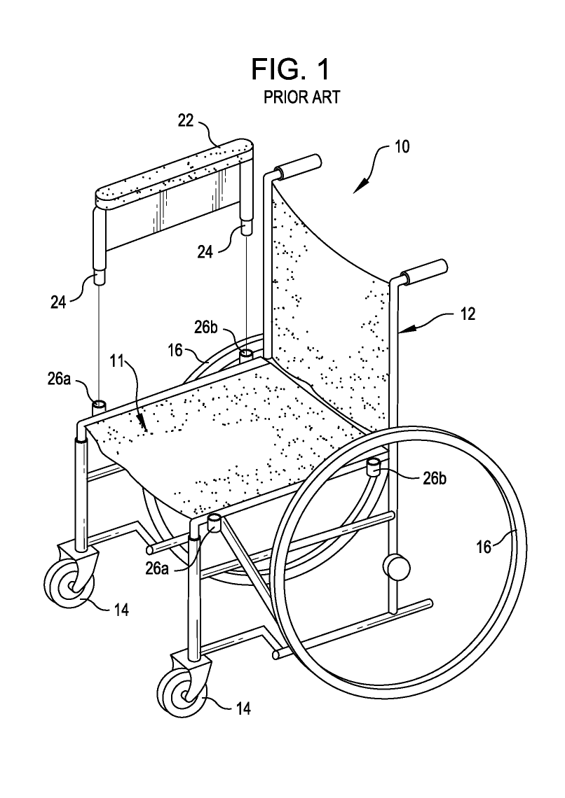

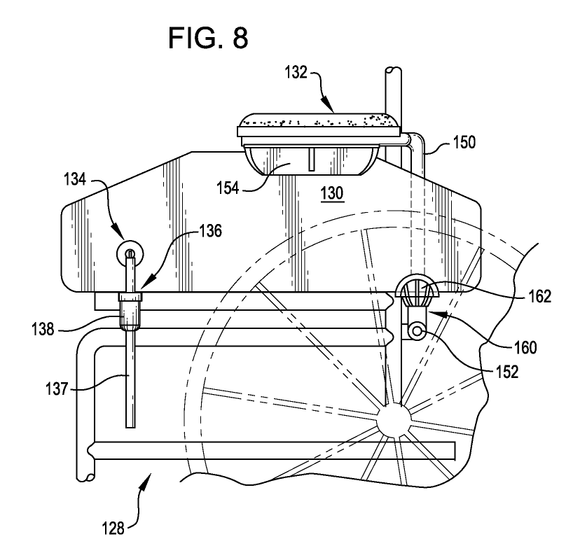

To aid in describing the environment in which present embodiments are to be utilized, FIGS. 1 to 7 and the associated description below are directed to the devices and structures described in U.S. Pat. Nos. 5,947,501 and 6,036,216, and are copied from those references without changes. The new embodiments are shown in and described relative to FIGS. 8 to 10.

Referring now to the drawings, in which like reference numerals represent like parts throughout the several views, FIG. 1 illustrates a prior art wheelchair 10. The wheelchair 10 is preferably a collapsible type well known in the medical industry, and includes a seating surface 11, a back 12, front wheels 14, and rear wheels 16. A rigid armrest 22 is shown in FIG. 1 for attachment to the right side of the seating surface 11. Although only one rigid armrest 22 is shown in the drawing, another armrest is typically provided on the opposite side of the wheelchair 10 and is a mirror image of the one shown. The rigid armrest 22 has tapered posts 24 which are adapted to slide into front and rear armrest receiving cylinders 26A and 26B. The armrest receiving cylinders 26A and 26B are attached to the wheelchair frame by a vertical and rectangular connector (not shown, but well known in the art). Generally, the tapered posts 24 of the rigid armrest 22 and armrest receiving cylinders 26A and 26B lock to each other by a spring (not shown, but well known in the art), which is either internal to the tapered posts 24 or external to the receiving cylinders 26A and 26B on the wheelchair 10.

FIG. 2 illustrates a combined transfer board 30 and removable armrest 32 in accordance with U.S. Pat. Nos. 5,947,501 and 6,036,216. As shown in FIG. 2, the transfer board 30 is vertically positioned along the left side of the wheelchair 10. The removable armrest 32 is positioned along the top longitudinal edge of the transfer board 30 and is removably attached to the transfer board. Briefly described, the transfer board 30 is attached to the wheelchair 10 by a rotatable and slidable coupling 34 that permits the transfer board to be rotated and moved downward from the armrest position shown in FIG. 2 to a transfer position as is shown in FIG. 7. The transfer board is shown in FIG. 7 as extending to a second seating surface 35, such as a bed.

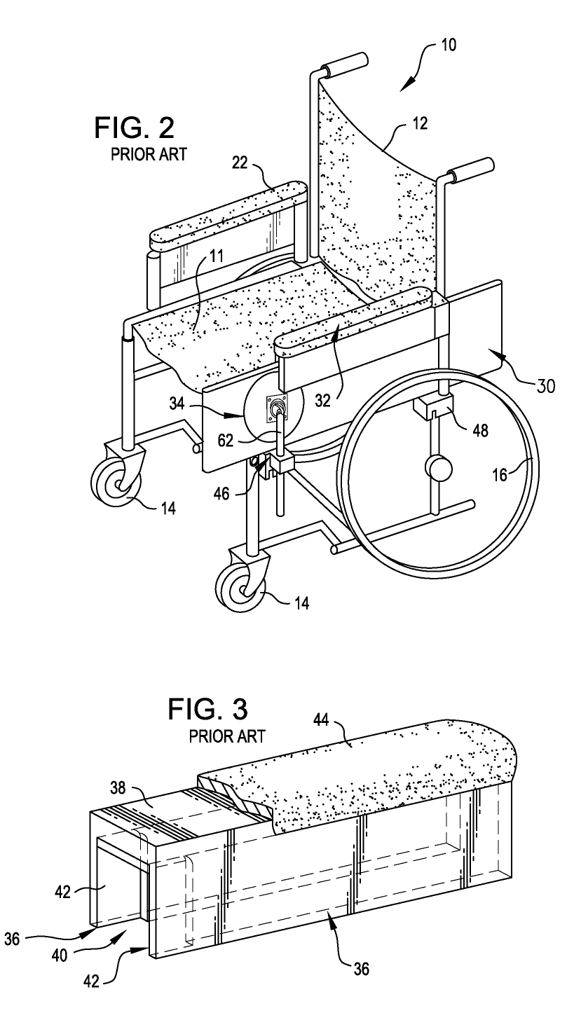

The transfer board 30 is composed of a smooth, lightweight material, preferably a finished wood product. The removable armrest 32 includes two vertical side walls 36 (FIG. 3) and a top 38 which create a longitudinal cavity 40 for receiving the top longitudinal edge of the vertically mounted transfer board 30. Widened slots 42 are located at the rear portion of the longitudinal cavity 40, the purpose of which will be discussed in detail below. A cushion 44 extends along the top 38 of the armrest 32 for providing comfort for a wheelchair passenger.

A front mount 46 and a rear mount 48 are provided for attaching the transfer board 30 to the wheelchair 10. The front mount 46 fits over the front armrest receiving cylinder 26A and is configured to receive the front end of the transfer board and the coupling 34. The rear mount 48 fits over the rear armrest receiving cylinder 26B and secures the back end of the transfer board 30 when the transfer board is in the stowed position of FIG. 2. The front and rear mounts 46, 48 may be held in place by a bolt (not shown) or similar fastener.

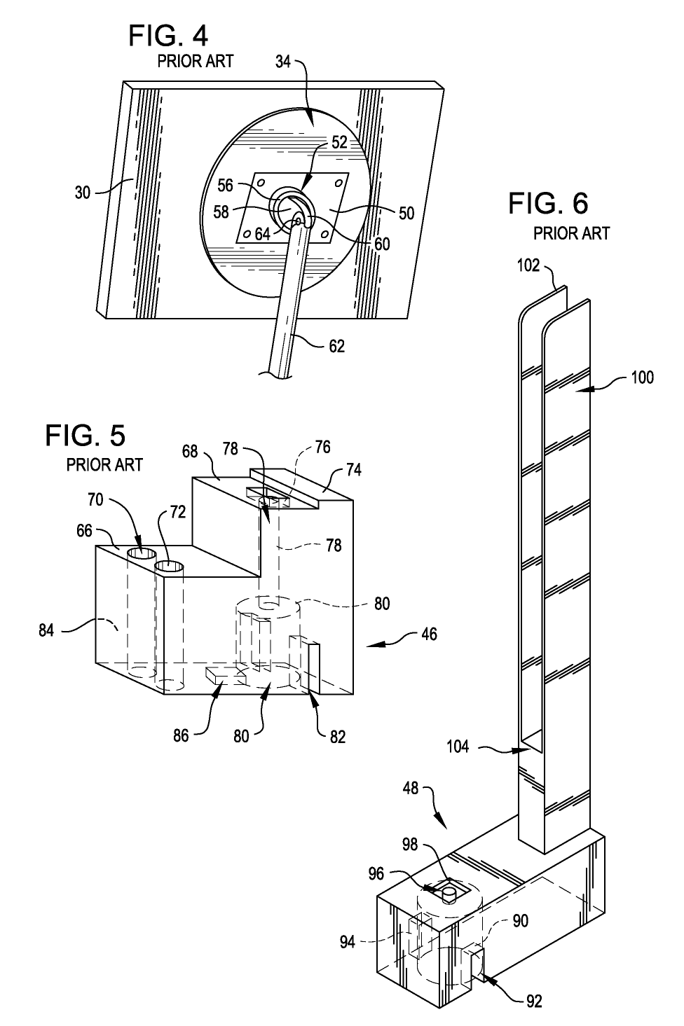

The coupling 34 secures the transfer board 30 to the front mount 46. As can best be seen in FIG. 4, the coupling 34 includes a plate 50 which attaches to a circular reinforcement 51 on the transfer board 30. The plate 50 and the circular reinforcement 51 are securely fastened to the transfer board 30 by screws, bolts or similar fasteners. Mounted at the center of the plate 50 is an annular bearing 52. The annular bearing 52 includes a plurality of ball bearings (not shown, but known in the art) housed between a stationary race 56 and a rotatable race 58.

As shown in FIG. 4, a flange 60 extends transversely from the rotatable race 58. A dowel 62 is rotatably attached to the flange 60 by a pin 64 or similar attachment. Other types of attachments or configurations may be used for providing preferably 180 degree pivotal movement of the dowel 62 relative to the transfer board 30.

The front mount 46 is set forth in detail in FIG. 5. As discussed earlier, the front mount 46 is configured to fit upon the front armrest receiving cylinder 26A. As shown by FIG. 5, the front mount 46 includes a short end 66 extending next to a tall end 68. Two dowel guide holes 70, 72 are bored vertically through the short end 66 and are positioned laterally adjacent to each other. The tall end 68 includes a raised ridge 74 extending along the top rear lateral edge. Also at the top of the tall end 68 is a bolt head insertion slot 76. The bolt head insertion slot 76 leads to a cylindrical channel 78 that descends vertically towards the bottom of the front mount 46. Approximately at the midpoint of the tall end 68, the cylindrical channel 78 opens to a larger hollowed cylinder 80, which extends to the bottom of the tall end 68. The hollowed cylinder 80 is preferably the same height, or slightly less than the height, of the front armrest receiving cylinder 26A of the wheelchair 10. Two rectangular slots 82, 84 extend from opposite sides of hollowed cylinder 80 to the sides of the front mount 46. The rectangular slots 82, 84 extend vertically from the bottom of the tall end 68 approximately ¾ the length of the hollowed cylinder 80. A third slot 86 extends from the forward portion of the hollowed cylinder 80 along the center of the bottom of the front mount 46 toward the dowel guide holes 70, 72. Preferably, the third slot 86 extends from the bottom of the tall end 68 about ⅓ the distance up the hollowed cylinder 80.

To install the front mount 46, the short end 66 is aligned toward the rear end of the wheelchair 10, and the hollowed cylinder 80 is placed over the forward armrest receiving cylinder 26A of the wheelchair. Rotation of the front mount 46 about the axis central to hollowed cylinder 80 is prevented by engagement of the rectangular slots 82, 84 with a connector (not shown, but well known in the art) attaching the forward armrest receiving cylinder 26A to the frame of the wheelchair 10. The third slot 86 receives external spring locks (not shown, but well known in the art) included on the armrest receiving cylinders 26A, 26B of some wheelchairs.

To secure the front mount 46 in place, a bolt (not shown) is inserted into the cylindrical channel 78. The head of the bolt is held securely by head insertion slot 76. A washer (not shown) and a nut (also not shown) are placed over the end of the bolt extending out of the bottom of the forward armrest receiving cylinder 26A and the front mount is tightened securely in place.

To mount the coupling 34 and the transfer board 30 on the front mount 46, the dowel 62 is inserted downward through either of two dowel guide holes 70, 72. If desired, the dowel 62 may include an attachment at its bottom end that is larger than the diameter of the dowel guide holes 70, 72, thus not allowing removal of the dowel 62 from the front mount 46. The dowel 62 is then rotated relative to the transfer board 30 until the dowel extends along the side of the transfer board in a direction which is transverse to the longitudinal axis of the transfer board. With this relationship established between the transfer board 30 and the coupling 34, the transfer board extends along the left side of the seating surface 11 of the wheelchair 10 in the armrest position shown in FIG. 2.

The attachment of the transfer board 30 to the wheelchair 10 via the front mount 46 and the coupling 34 makes transfer much easier for a wheelchair occupant. The pivotal mounting of the dowel 62 relative to the flange 60 permits the transfer board 30 to rotate about its longitudinal axis. In addition, the swivel mounting of the rotatable race 58 relative to the stationary race 56 allows the transfer board 30 to rotate about the dowel 62. Also, the dowel 62 can slide up and down in the front mount 46, allowing the transfer board 30 to be lowered to the level of the seating surface 11 of the wheelchair 10. It also allows the unit to be raised in the vertical position providing clearance for the board to be pivoted, from the coupling 34, and inserted or removed form the rear mount 48. Thus, the attachment of the transfer board 30 to the wheelchair 10 via the front mount 46 and the coupling 34 permits a variety of different arrangements for the transfer board 30, all in which the transfer board is stabilized by its attachment to the wheelchair. This attachment prevents the transfer board 30 from sliding off the wheelchair during body transfers. It also lessens the length of the transfer board 30 required for placement underneath the transferee at the beginning of a transfer.

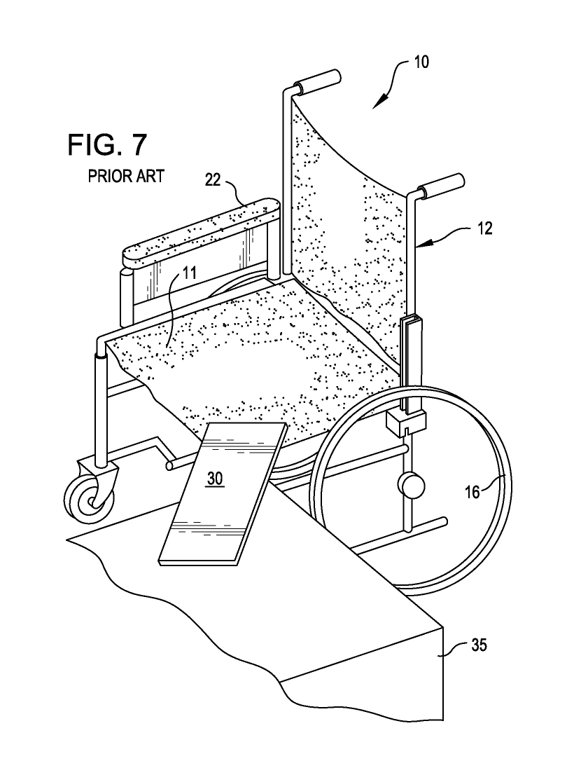

Referring to FIG. 6, the rear mount 48 is an L-shaped piece that mounts on the rear receiving cylinder 26B. The rear mount 48 includes a hollowed cylinder 90 with side slots 92 and 94 that receive the rear armrest receiving cylinder 26B and are similar to that found on front mount 46. A cylindrical channel 96 extends along the vertical centerline of the hollowed cylinder 90 to a bolt insertion slot 98 that opens at the top of the base of the L-shaped rear mount 48. Extending from the base of the rear mount 48 are two parallel guides 100 and 102. The parallel guides 100 and 102 are joined at their lower ends such that a shelf 104 is formed. The parallel guides 100 and 102 are separated by a distance which is slightly greater than the width of the transfer board 30.

Similar to the front mount 46, the hollowed cylinder 90 fits over the wheelchair's rear armrest receiving cylinder 26B. Rotation of the rear mount 48 around the receiving cylinder 26B is prevented by the coupling of the side slots 92, 94 and the vertical connector between the frame of the wheelchair 10 and the receiving cylinder 26B. A bolt (not shown) fits through channel 96 to fasten the rear mount 48 securely to the receiving cylinder 26B. The head of the bolt is refrained from rotation by insertion slot 98. A washer and nut (both not shown) are threaded over the end of the bolt extending out of the bottom of the rear armrest receiving cylinder 26B and the rear mount 48 is tightened securely in place.

The rear mount 48 receives the back end of the transfer board 30 when the transfer board is in the stowed position of FIG. 2. The transfer board 30 rests on the shelf 104 and is supported laterally by the parallel guides 100 and 102. The parallel guides 100 and 102 are positioned behind the back 12 of the wheelchair to prevent injury and to allow for the unrestricted assembly of the wheelchair 10 from a collapsed state. When the transfer board 30 is in place, the removable armrest 32 is placed on the top longitudinal edge of the transfer board 30 and the parallel guides 100 and 102 are matched with the slots 42 in the longitudinal cavity 40 of the removable armrest. The height of the lateral parallel guide 100 could be produced shorter that the medical parallel guide 102. This version, though less compatible with both sides of the wheelchair 10, would provide greater ease for those with tremors or visual impairments to insert the vertical board 30 into the longitudinal cavity 40 in the stowed position.

The above-described combination transfer board 30 and removable armrest 32 provides many advantages not available in prior art transfer boards. Because the transfer board 30 is attached to the wheelchair, the transfer process is stabilized and the risk of the patient falling during the transfer process is minimized. In addition, the transfer board 30 is always readily available, because it is a part of the wheelchair. A patient can access the transfer board 30, manipulate it to the transfer position, and perform a successful transfer without the help of an additional person. Thus, the device provides an independence for the wheelchair occupant which was not available with prior art transfer boards.

Although the transfer board 30 has been described in detail with reference to a wheelchair 10, it is to be understood that the concepts described herein could be used in conjunction with many different seating surfaces, including, but not limited to, a bed, a stationary chair, or any other seating surface. The transfer board may or may not include an armrest in these other applications.

FIG. 8 shows a combination of a wheelchair 128 and a transfer board 130 in accordance with an embodiment. Although only portions of the wheelchair 128 are shown, the structure and arrangement of wheelchairs are known in the art, and a wheelchair having a structure similar to the prior art wheelchair shown in FIG. 1, for example, may be used in connection with the embodiment.

The transfer board 130 is connected to the wheelchair 128 utilizing a coupling 134 that is similar to the coupling 34 described above. In addition, in accordance with an embodiment, a unique, plastic, self-locking plug 136 is utilized for connecting a sliding rod 137 of the coupling 134 to the wheelchair 128, and specifically to the armrest receiving cylinder 138, similar to the armrest receiving cylinder 26a in FIG. 1. Although the embodiments described herein utilize the plug 136, the coupling 134 may be attached to the wheelchair using a different structure.

The plastic self-locking plug 136 includes an upper flange 140 (best shown in FIG. 11) attached to a cylindrical body 142. The upper flange 140 limits insertion of the plug 136 into the receiver 138. A bore 144 extends through the cylindrical body 142 and the upper flange 140. In accordance with an embodiment, the plastic self-locking plug 136 includes a structure, such as a swedged section or lower flanges 146, which causes the plastic self-locking plug to lock into place once pressed into the armrest receiving cylinder 138. The swedged section or flanges 146 at the bottom of the plastic self-locking plug 136 allow the plug to lock into place after pressed down into the armrest receiving cylinder 138. Thus, the plastic self-locking plug 136 may be positioned within the armrest receiving cylinder 138 without the use of tools, and provides a solid anchor for attachment of the coupling 134 via the sliding rod 137. In use, the sliding rod 137 fits within the bore 144 of the plastic self-locking plug 136. Removal of these plastic, self-locking pug 136 may be provided, for example, by bending lower flanges 146, or overcoming the swedging force provided by swedging structure, if provided.

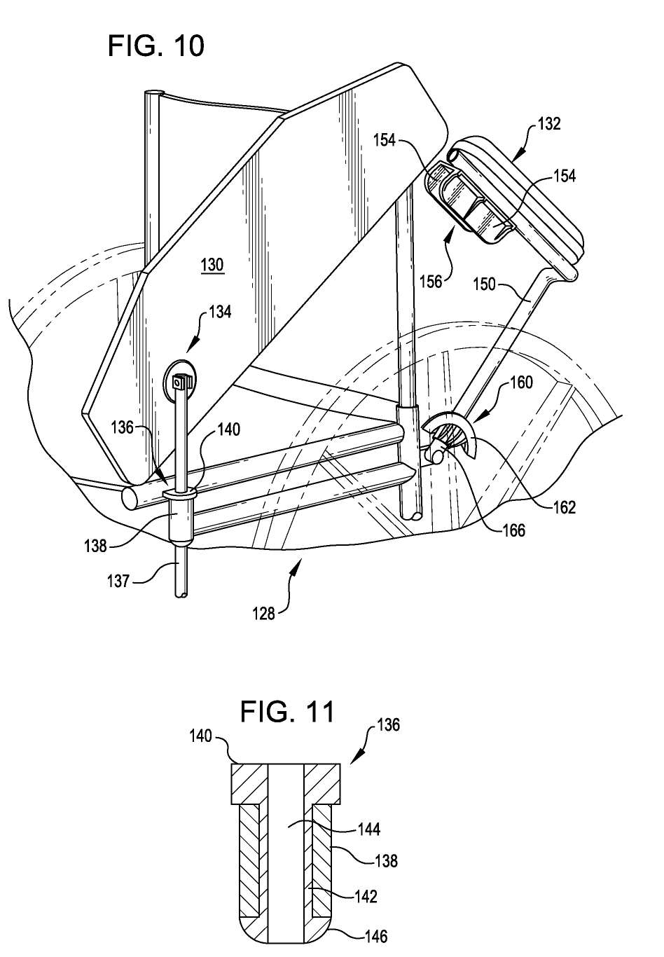

In accordance with an embodiment, a flip-back armrest 132 is provided that lowers upon and secures the transfer board in a vertical position at the side of the wheelchair 128. In the embodiment shown in the drawings, the flip-back armrest 132 is mounted on a post 150 that is bent to a right angle, as is shown in FIG. 10. The post 150 is attached to a frame of the wheelchair 128 by a pivot fastener 152. The pivot fastener 152 permits the post 150 and the flip-back armrest 132 to pivot relative to the wheelchair from the storage position shown in FIG. 8 to the flipped-back position shown in FIG. 10.

The flip-back armrest 132 includes sidewalls 154, best shown in FIG. 10. These sidewalls are adapted to extend on opposite sides of the transfer board 130 when the transfer board is aligned against one side of the wheelchair 128, such as in the storage position shown in FIG. 8. To this end, the sidewalls 154 define a slot 156 or channel into which the top edge of the transfer board 130 is received in the storage position shown in FIG. 8.

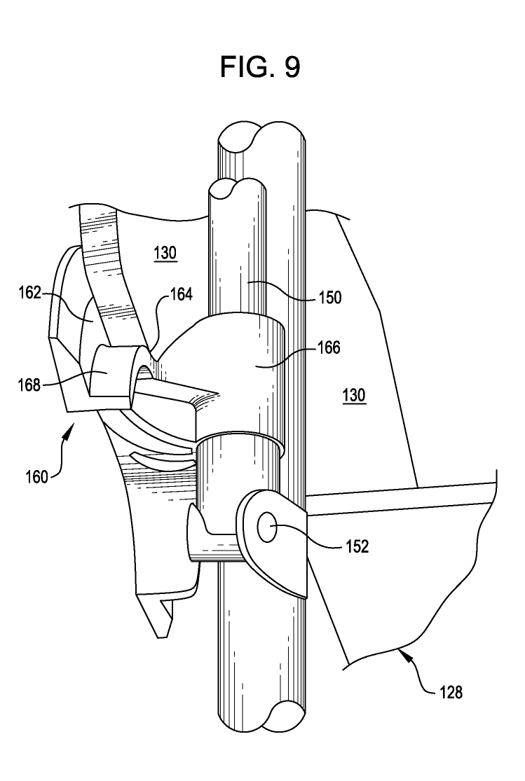

In accordance with an embodiment, as best shown in FIG. 9, a rear landing pad 160 is provided that is attached to the post 150. The rear landing pad is positioned and arranged so that it receives a rear portion of the transfer board 130 when the transfer board is in the stowed position shown in FIG. 8. In the embodiment shown in the drawings, the rear landing pad 160 includes an outer sidewall 162 that is adapted to extend along and support an outer side of the transfer board 130 when the transfer board is in the stowed position shown in FIG. 8. A horizontal support 164 extends from the outer sidewall 162 to the post 150.

In the embodiment shown in the drawings, the rear landing pad 160 includes a sleeve 166 that fits around the post 150. In this manner, the rear landing pad 160 moves backward with the flip-back armrest 132 when the post 150 is pivoted backward.

In use, the flip-back armrest 132 is maintained in the storage position shown in FIG. 8 during storage or normal use of the wheelchair. If a wheelchair user wishes to use the transfer board 130, the user rotates or flips back the flip-back armrest 132 from the position shown in FIG. 8 to the position shown in FIG. 10. In this position, the flip-back armrest 132 is moved out of the way so that the transfer board 130 may be lifted upright and utilized as described above with reference to the prior art design.

In an embodiment, as the flip-back armrest 132 is pivoted backwards, the rear end of the transfer board 130 remains supported on the horizontal support 164 and between the post 150 and the outer sidewall 162 of the rear landing pad 160. Thus, in accordance with the embodiment, during the entire movement, the rear end of the transfer board 160 still supported by the horizontal support 164. As such, in rotating the flip-back armrest 132 backwards, the transfer board does not fall, but continues to be supported by the rear landing pad 160. To aid in a smooth transition between the storage position shown in FIG. 8 to the flipped-back position in FIG. 10, the horizontal support 164 of the rear landing pad 160 may include a rounded surface 166, as shown in FIG. 9. This rounded surface 166 permits the transfer board 130 to smoothly roll over the rear landing pad 160 as the flip-back armrest 132 is rotated rearward.

The features of the combined transfer board 130 and flip-back armrest 132 provide many cost savings for manufacturers. First, the front armrest receiver that is already provided on a wheelchair may be utilized for mounting of the transfer board 130. In addition, many wheelchairs already include a flip-back armrest and cushion, and such armrests and cushions may be used by adding the channel 156 to the bottom of the existing flip-back armrest. As an alternative, the flip-back armrest 132 may replace an existing flip-back armrest, or a mount may be provided for adding a flip-back armrest to a wheelchair that does not have a flip-back armrest.

Decreased weight is achieved over prior art wheelchair/transfer board combinations by utilizing the small plastic parts of the current embodiment. The plug 136 and the rear landing pad 160 are both smaller and lighter in weight than their counterparts in the prior art. In addition, in comparison to the prior art combination wheelchair and transfer board described above, the flip-back armrest is easier to use because it cannot be lost and is not cumbersome to stow, but instead remains attached to the wheelchair as it is flipped backward. Finally, the low profile, rear landing pad 160 does not extend upward very far, so it does not catch clothing or the arm of the user.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A combination, comprising:
a wheelchair;
a transfer board pivotally and rotatably attached to the wheelchair between a storage position where the transfer board is attached to the wheelchair and extends along one side of the wheelchair and a use position where the transfer board is attached to the wheelchair and may be used to transfer a patient from the wheelchair to another surface; and
a flip-back armrest attached for pivoting movement to the wheelchair between a securing position where the armrest is attached to the chair and secures a top portion of transfer board and a release position where the armrest is attached to the wheelchair, and is flipped back from the secure position to permit the transfer board to move from the storage position to the use position.

2. The combination of claim 1, wherein the armrest includes a channel for receiving a top edge of the transfer board when the armrest is in the securing position.

3. The combination of claim 1, further comprising a rear landing pad for receiving a rear portion of the transfer board when the transfer board is in the storage position, the rear landing pad being mounted for pivoting movement with the armrest.

4. The combination of claim 3, wherein the rear landing pad includes a rounded upper surface so that the transfer board rolls over the upper surface as the armrest pivots back.

5. The combination of claim 4, wherein the armrest is attached for pivoting with a post, and wherein the rear landing pad comprises an outer wall, and the transfer board is captured between the outer wall and the post when the transfer board is in the storage position.

6. The combination of claim 5, wherein the rear landing pad comprises a sleeve that extends around the post.

7. The combination of claim 3, wherein the armrest is attached for pivoting with a post, and wherein the rear landing pad comprises an outer wall, and the transfer board is captured between the outer wall and the post when the transfer board is in the storage position.

8. The combination of claim 7, wherein the rear landing pad comprises a sleeve that extends around the post.

9. The combination of claim 1, further comprising a self locking plug for attaching the transfer board to a armrest receiver on the wheelchair.

10. The combination of claim 9, wherein the self locking plug includes a structure for locking the plug into place in the receiver.

11. The combination of claim 9, wherein the self-locking plug comprises an upper flange for limiting insertion of the plug into the receiver.

12. A transfer board combination for connecting to a wheelchair, comprising:
a transfer board;
a connector for pivotally and rotatably attaching the transfer board to the wheelchair between a storage position where the transfer board is attached to the wheelchair and extends along one side of the wheelchair and a use position where the transfer board is attached to the wheelchair and may be used to transfer a patient from the wheelchair to another surface; and
a structure for attaching on the bottom of a flip-back armrest that is pivotally attached to a wheelchair, the structure being arranged so that the armrest secures a top edge of the transfer board in a securing position and release the top edge when the armrest is flipped back from the secure position to permit the transfer board to move from the storage position to the use position.

13. The combination of claim 12, wherein the structure includes a channel on the bottom of the armrest for receiving a top edge of the transfer board when the armrest is in the securing position.

14. The combination of claim 12, further comprising a rear landing pad for receiving a rear portion of the transfer board when the transfer board is in the storage position, the rear landing pad being mountable for pivoting movement with the armrest.

15. The combination of claim 14, wherein the rear landing pad includes a rounded upper surface so that the transfer board rolls over the upper surface as the armrest pivots back.

16. The combination of claim 15, wherein the armrest is attached for pivoting with a post, and wherein the rear landing pad comprises an outer wall, and wherein, when the rear landing pad is attached to the wheelchair, the transfer board is captured between the outer wall and the post when the transfer board is in the storage position.

17. The combination of claim 16, wherein the rear landing pad comprises a sleeve that extends around the post when the rear landing pad is attached to the wheelchair.

18. The combination of claim 14, wherein the armrest is attached for pivoting with a post, and wherein the rear landing pad comprises an outer wall, and wherein, when the rear landing pad is attached to the wheelchair, the transfer board is captured between the outer wall and the post when the transfer board is in the storage position.

19. The combination of claim 18, wherein the rear landing pad comprises a sleeve that extends around the post when the rear landing pad is attached to the wheelchair.

20. The combination of claim 12, further comprising a self locking plug for attaching the transfer board to a armrest receiver on the wheelchair.

21. The combination of claim 20, wherein the self locking plug includes a structure for locking the plug into place in the receiver.

22. The combination of claim 12, further comprising the flip-back armrest.

23. The combination of claim 22, further comprising a structure for pivotally attaching the flip-back armrest to a wheelchair.
